(19) United States
(12) Patent Application Publication
(10) Pub. No.: US 2017/0167137 A1
(43) Pub. Date: Jun. 15, 2017

(54) PREFABRICATED CONCRETE WALL STRUCTURES

(71) Applicant: Build Smart IP, LLC, Lawrence, KS (US)

(72) Inventor: Kent R. Erickson, Overland Park, KS (US)

(73) Assignee: Build Smart IP, LLC, Lawrence, KS (US)

(21) Appl. No.: 15/379,050

(22) Filed: Dec. 14, 2016

Related U.S. Application Data
(60) Provisional application No. 62/267,499, filed on Dec. 15, 2015.

(51) Int. Cl. E04C 2/288; E04B 1/76; B28B 23/22; B28B 1/14; B28B 23/00; E04B 2/56; E04B 2/00

(52) U.S. Cl. CPC E04C 2/2885; E04B 2/56; E04B 1/7608; E04C 2/46; B28B 1/14; B28B 23/005; B28B 23/22; E04B 2103/02; E04C 2/06

(57) ABSTRACT

A method for forming insulated concrete wall panels includes the step of positioning a stud wall frame in a casting bed, positioning a support panel formed from a single, monolithic section of foam insulating material on the wall frame with grooves formed in a first face therein on the stud wall frame with the grooves facing away from the wall frame and then pouring concrete in the casting bed over and around the first face of the support panel to form a layer of concrete with portions of the concrete extending into the grooves in the support panel. The concrete is allowed to cure and the wall structure is then removed from the casting bed.

### CROSS-REFERENCE TO RELATED APPLICATIONS

This application claims the benefit of U.S. Provisional Patent Application No. 62/267,499, filed Dec. 15, 2015, the disclosure of which is hereby incorporated herein in its entirety by reference.

### BACKGROUND OF THE INVENTION

Field of the Invention

This invention relates to prefabricated concrete wall structures.

Description of the Related Art

U.S. Pat. No. 8,491,831 discloses assembly systems and methods for forming concrete wall structures with a plurality of foam insulating blocks encased in the structure. The structure is formed by positioning a conventional frame for forming a wall within a casting bed, positioning a support panel formed from insulating material on the frame and then positioning a plurality of foam insulating blocks on the support panel and spacing the blocks apart by a support beam placed therebetween, and then pouring concrete over the foam insulating blocks to form a layer of concrete with portions of the concrete extending into the spaces between the spaced apart foam insulating blocks. The system and method is somewhat labor intensive in having to space the foam blocks apart and position support beams therebetween.

### SUMMARY OF THE INVENTION

The present invention is an improvement over the concrete wall system and method of fabrication disclosed in U.S. Pat. No. 8,491,831, the disclosure of which is incorporated by reference. In the improved system and method, foam insulating segments are formed integral with the support panel and may be referred to as an insulating panel. The insulating panel for a wall segment is formed from a single, monolithic section of insulating material such as foam. The insulting panel is rectangular in shape with dimensions selected to conform with the dimensions of the wall frame. A plurality of grooves are formed in the insulating panel and preferably extend transverse to upper and lower edges thereof and parallel to side edges of the insulating panel. In one embodiment, the grooves extend in equally spaced relation forming insulating segments having a common width. In other embodiments the grooves may be irregularly spaced forming insulating segments of varied widths.

### BRIEF DESCRIPTION OF THE DRAWINGS

FIG. 1 is a perspective view of an insulated concrete wall panel formed in accordance with the methods and materials disclosed herein.

FIG. 2 is a cross-sectional view of the insulated concrete wall panel taken along line 2-2 of FIG. 1.

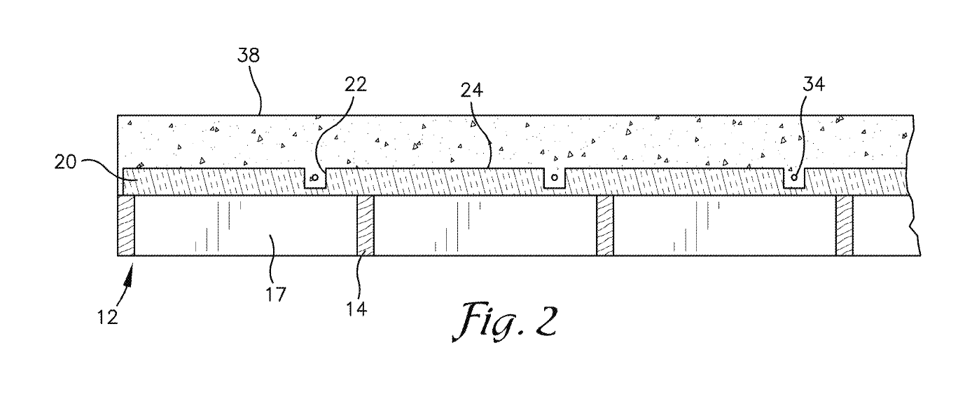

FIG. 3 is a top plan view of a casting bed for forming the insulated concrete wall panel with a stud-wall frame positioned therein.

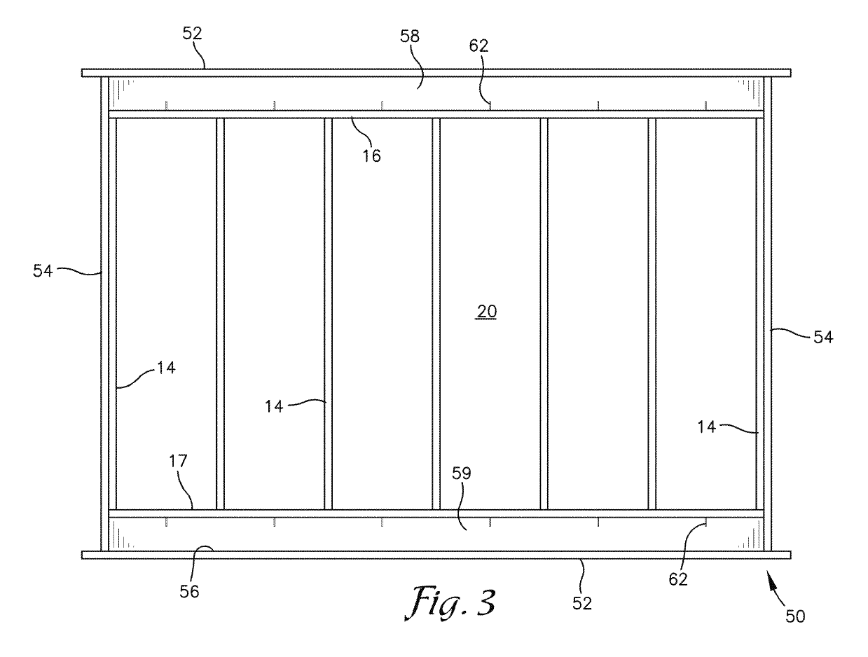

FIG. 4 is a top plan view of the casting bed with an insulated panel having grooves formed therein positioned over the stud-wall frame.

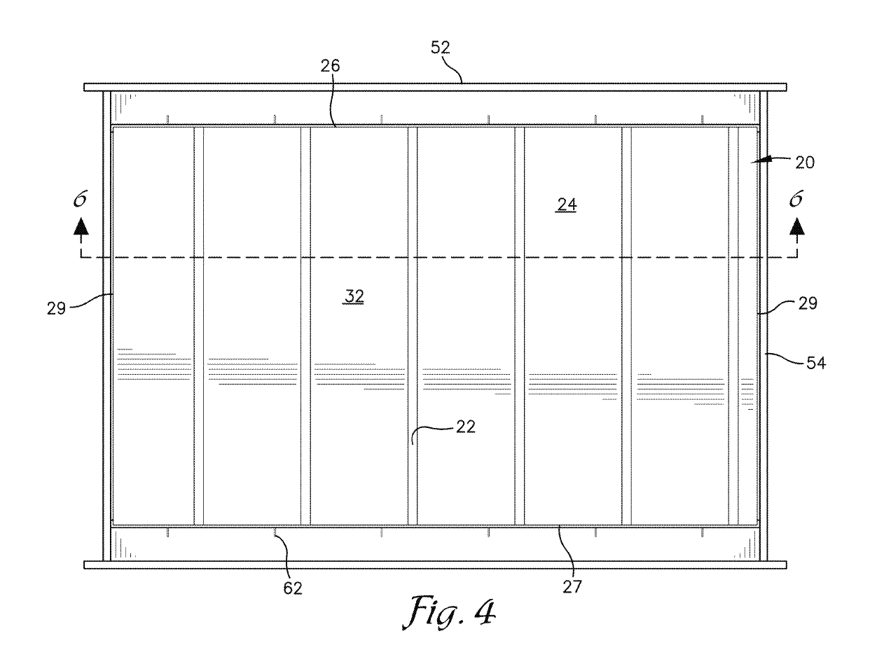

FIG. 5 is a top plan view of the casting bed with reinforcing members positioned within the grooves of the insulated panel and along gaps between the insulated panel and the casting.

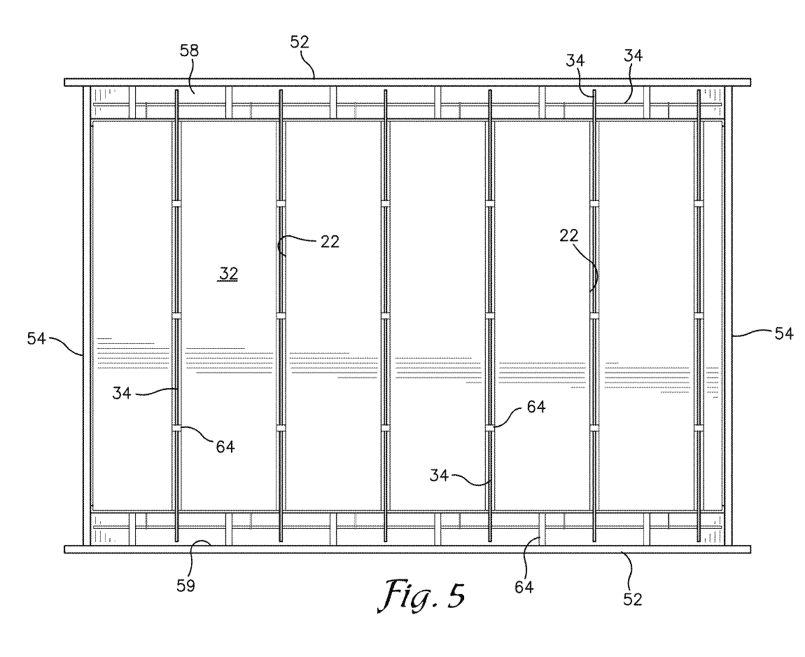

FIG. 6 is a cross-sectional view taken along line 6-6 prior to positioning reinforcing members in the grooves of the insulated panel.

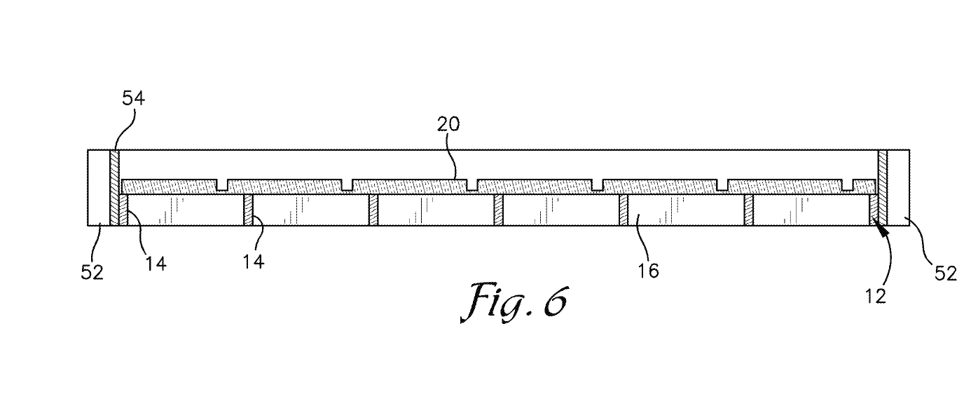

### DETAILED DESCRIPTION OF THE PREFERRED EMBODIMENTS

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for teaching one skilled in the art to variously employ the present invention in virtually any appropriately detailed structure. The drawings constitute a part of this specification and include exemplary embodiments of the present invention and illustrate various objects and features thereof.

Certain terminology will be used in the following description for convenience in reference only and will not be limiting. For example, the words “upwardly,” “downwardly,” “rightwardly,” and “leftwardly” will refer to directions in the drawings to which reference is made. The words “inwardly” and “outwardly” will refer to directions toward and away from, respectively, the geometric center of the embodiment being described and designated parts thereof. Said terminology will include the words specifically mentioned, derivatives thereof and words of a similar import.

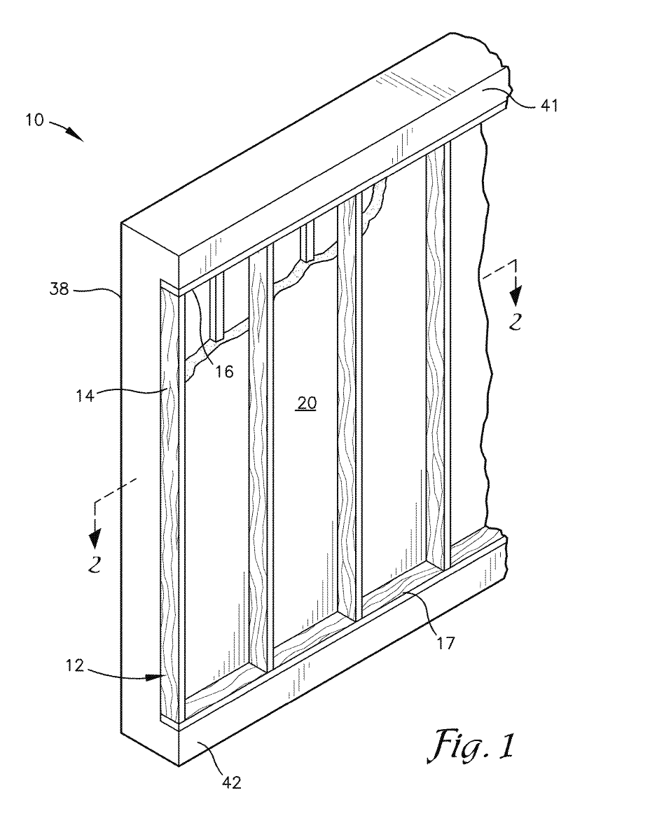

FIG. 1 shows a concrete wall assembly 10 formed using materials and methods in accordance with the present invention. The wall assembly 10 is generally formed starting with a stud-wall frame 12 of generally conventional construction and formed from a plurality of spaced apart vertical wall studs 14 connected by a horizontally extending top plate 16 and base plate 17. An insulated panel or insulating layer 20 is positioned over and on the stud wall frame 12. The insulating panel 20 may be formed from an expanded foam material and is preferably sized similar to the stud-wall frame 12 in width and height. The insulating panel 20 may also be sized smaller or larger than the frame 12. The insulating panel 20 may be adhered to the stud-wall frame 12 using known adhesives, attached using mechanical fasteners or simply laid on the frame 12.

A plurality of grooves 22 are formed in the insulating panel 20 and extend into the outer face 24 which faces away from the frame 12. In the embodiment shown, grooves 22 extend transverse to upper and lower edges 26 and 27 of the insulating panel 20 and parallel to side edges 29 thereof. The grooves 22 are shown as extending in equally spaced relation forming insulating segments 32 having a common width. Structural reinforcing members 34, such as rebar for example, are supported in the grooves 22 and across and proximate the upper and lower edges 26 and 27 of the insulating panel 20. A concrete layer 38 is formed over and across the outer face 24 of the insulating panel 20 with concrete extending into the grooves 22 and around the upper and lower edges 26 and 27 of the insulating panel 20 to form a concrete header 41 and footer 42.

The concrete wall assembly 10 is formed using a casting bed 50 as described in U.S. Pat. No. 8,491,831 including first and second pairs of opposing boards or panels 52 and 54 positioned relative to one another to form a rectangular space 56 for receiving stud-wall frame 12 and insulated panel 20. The height of the casting bed panels 52 and 54 and the space formed therebetween corresponds to the desired thickness of the concrete wall assembly 10.

The casting bed panels 54 are preferably positioned so that the width of the space 56 matches the width of the stud-wall frame 12 to be positioned therein. Casting bed panels 52 are preferably positioned so that a gap 58 is formed between stud-wall top plate 16 and the proximate casting bed panel 52 and a gap 59 is formed between stud-wall base plate 17 and the proximate casting bed panel 52. Fasteners 62 such as nails or screws may be partially driven into the top and bottom plates 16 and 17 of the frame 12 to extend into the gaps 58 and 59 to provide additional structure for connecting the concrete layer 38 to the stud-wall frame 12 and for securing structural reinforcing members 34 extending across the upper and lower edges 26 and 27 of the insulating panels.

The stud wall frame 12 with or without the insulating panel 20 adhered thereto is positioned in the space 56 formed by the casting bed panels 54. If not previously adhered to frame 12, the insulating panel 20 is then laid over the frame 12 with the outer face 24 of the panel facing upward. The frame 12 is preferably positioned between casting bed panels 52 so that the gaps 58 and 59 are sized equally. Reinforcing members or rebar 34 may then be secured to the fasteners 62 or otherwise supported in the gaps 58 and 59 by support members or spacers 64 so that a reinforcing member 34 extends across each gap 58 and 59 along the length of the top or bottom plates 16 and 17 of stud-wall frame 12.

Additional reinforcing members 34 are then positioned in each of the grooves 22 formed in the insulating panel 20 and may be supported in place by spacers or support embers 64 positioned in the grooves and engaging the insulating panel 20. Ends of the reinforcing members 34 in grooves 22 may be tied to or otherwise connected to the reinforcing members 34 extending in gaps 58 and 59 to tie the reinforcing members together for additional reinforcement and support of the concrete layer 38.

Once the reinforcing members 34 are properly positioned and tied together, concrete is poured over the insulating panel 20 flowing into the gaps 58 and 59 and grooves 22 and around the reinforcing members 34. The uncured concrete is then leveled and finished using conventional concrete leveling and finishing techniques and preferably to the height of the casting bed panels 52 and 54. The concrete is allowed to cure and then, the casting bed panels 52 and 54, which preferably are treated with a release agent, are removed from the cured concrete wall assembly 10 which can then be used in constructing a concrete wall.

The grooves 22 formed in the insulating panels 20 are preferably at least three times wider and deep as the reinforcing members 34 to allow equal volumes of concrete to extend around the reinforcing members 34 in the grooves 22. The grooves 22 preferably are formed in the insulating panels 20 prior to attachment to the frame 12 but it is foreseen that the grooves could be cut into the insulating panels 20 after attachment to the frames 12.

It is to be understood that while certain forms of the present invention have been illustrated and described herein, it is not to be limited to the specific forms or arrangement of parts described and shown.

Having thus described the invention, what is claimed as new and desired to be secured by this patent is as follows:

1. A method for forming a wall structure comprising the steps of:
positioning a rectangular wall frame formed from a plurality of studs within a casting bed;
positioning a support panel formed from a single, monolithic section of foam insulating material on the wall frame; the foam insulting panel is formed rectangular in shape with dimensions selected to conform with the dimensions of the rectangular wall frame; a plurality of grooves are formed in a first face of the support panel and the support panel is positioned on the rectangular wall frame such that the first face faces away from rectangular wall frame; and
pouring concrete in the casting bed over and around the first face of the support panel to form a layer of concrete with portions of the concrete extending into the grooves in the support panel;
allowing the concrete to cure; and
removing the wall structure from the casting bed.

2. The method of forming a wall structure as in claim 1 wherein the plurality of grooves in the first face extend in parallel relation.

3. The method of forming a wall structure as in claim 2 wherein the plurality of grooves in the first face extend parallel to side edges of the support panel.

4. The method of forming a wall structure as in claim 1 wherein the step of positioning the support panel on the wall frame includes the step of adhering the support panel to the wall frame.

5. The method of forming a wall structure as in claim 1 wherein prior to the step of pouring concrete, a reinforcing member is positioned in each groove.

6. A wall structure formed by the method of claim 1.

7. A method for forming a wall structure comprising the steps of:
providing a casting bed having upper and lower casting bed panels and first and second side panels;
forming a rectangular wall frame from a plurality of studs;
positioning the rectangular wall frame in the casting bed wherein an upper gap is formed between a top plate of the rectangular wall frame the upper casting bed panel and a lower gap is formed between a base plate of the rectangular wall frame and the lower casting bed panel;
forming a support panel from foam insulating material in a rectangular shape with dimensions conforming to the dimension of the rectangular wall frame and forming a plurality of grooves in a first face of the support panel;
adhering the support panel to the rectangular wall frame such that the first face faces away from rectangular wall frame; and
pouring concrete in the casting bed over and around the first face of the support panel to form a layer of concrete with portions of the concrete extending into the grooves in the support panel and within the upper and lower gaps;
allowing the concrete to cure; and
removing the wall structure from the casting bed.

8. The method of forming a wall structure as in claim 7 wherein the plurality of grooves in the first face extend in parallel relation.

9. The method of forming a wall structure as in claim 8 wherein the plurality of grooves in the first face extend parallel to side edges of the support panel.

10. The method of forming a wall structure as in claim 7 wherein prior to the step of pouring concrete, a reinforcing member is positioned in each groove.

11. A wall structure formed by the method of claim 7.
